(19) United States
(12) Patent Application Publication
(10) Pub. No.: US 2004/0059566 A1
(43) Pub. Date: Mar. 25, 2004

(54) Method of checking patent claims

(76) Inventors: Ronny Fogel, Givataim (IL); Shlomit Fogel, Givataim (IL)

Correspondence Address: HALE AND DORR LLP, 300 PARK AVENUE, NEW YORK, NY, 10022, US

(21) Appl. No.: 10/252,953

(22) Filed: Sep. 23, 2002

(51) Int. Cl. G06F 17/27

(52) U.S. Cl. 704/9; 715/507

(57) ABSTRACT

A method for checking semantic and syntactical correctness of patent claims. The method first checks for sequential claims numbering. For each claim a type and dependency are determined and the dependencies are checked for type match. Each claim is then parsed and checked for syntactical correctness and for correct antecedent basis for all its terms.

### FIELD OF THE INVENTION

The present invention relates to patent drafting in general and to drafting the claims of a patent in particular. The method of the present invention provides a tool for checking drafted claims.

### BACKGROUND OF THE INVENTION

Applications for patents to protect inventors' ideas are filed with the United States Patent and Trademark Office and with other patent offices throughout the world. Traditionally, an inventor seeks the assistance of a trained patent application draftsman, either a patent attorney or patent agent in the United States or the equivalent in foreign countries.

Patent attorneys, patent agents and individual applicants have a variety of methods for application drafting. In addition, there are a number of books available on patent law, patent office practice, patent examiners' procedure and even the drafting of patent applications. Further, there is a computer software application designed to assist the individual inventor in preparing a patent application entitled Patent It Yourself available from Nolo Press, Calif.

Drafting patent claims, especially in cases where tens (and sometimes hundreds) of claims are being drafted, is a tedious, error-prone task. Changes are often made at the last moment, or claims added, making it necessary to revise all the claims. In the course of testing the method of the present invention the inventor has applied the method to hundreds of granted US Patents. Approximately 10% were found to have errors in their claims. The percentage would certainly be much higher when checking newly drafted patents.

U.S. Pat. No. 5,774,833 to Newman provides a method for processing patent text in a computer, including identifying boundaries of parts of the patent text, loading at least one part into memory, analyzing the loaded text and reporting results to a user. The method includes checking the claims part of the patent.

U.S. Pat. No. 6,049,811 to Petruzzi, et al. provides a machine and method for drafting a patent application. The computer requests and stores information regarding the invention, according to each consecutive part of the patent being drafted.

There is a need for an automatic method and a tool of checking patent claims, to be used by the person drafting the patent or by the patent examiner.

### SUMMARY OF THE INVENTION

In one aspect, the present invention provides a method of checking the correctness of at least one patent claim, comprising the steps of:

checking sequential numbering of said at least one claim;

determining a claim-type for each of said at least one claim, said claim-type selected from a group consisting of method, apparatus, product-by-process, method-of-producing and unknown;

assigning a dependency-type to each of said at least one claim, said dependency-type selected from a group consisting of dependent and independent;

building a dependencies-tree for each of said at least one claim assigned the dependency-type dependent in said step of assigning, said dependencies-tree comprising at least one independent claim;

checking type-match for each of said dependent claims and for each of said claims in said dependencies-tree of said dependent claim; and

parsing each of said at least one claim, said step of parsing comprising the steps of:

a) checking for correct syntax; and

b) checking for correct antecedent basis.

In the step of determining a claim-type, the method uses language dependent assisting lists, comprising: a method-words list, an apparatus-words list, a product-by-process list and a method-of producing list.

In a first embodiment, the method determines a claim type to be Method, if:

said claim comprises no method-words;

said claim comprises no apparatus-words; and

said claim comprises one of ‘step’ and ‘steps’;

Or:

said claim comprises at least one method-word;

said claim comprises no apparatus-words;

said claim comprises no product-by-process words;

said claim comprises no method-of-producing words; and

said claim comprises at least one of a group consisting of ‘step’, ‘steps’ and;

said claim starts with ‘method’ or ‘a method’;

Or:

said claim comprises at least one apparatus-word;

said claim comprises no method-words; and

said claim comprises one of ‘step’ and ‘steps’;

Or:

said claim comprises at least one apparatus-word;

said claim comprises at least one method-word; and

said claim comprises no method-of-producing words,

wherein the first of said at least one apparatus-word appears after the first of said at least one method-word;

Or:

said claim comprises at least one apparatus-word;

said claim comprises at least one method-word; and

said claim comprises one of ‘step’ and ‘steps’,

wherein the first of said at least one apparatus-word appears after the first of said at least one apparatus-word.

In a second embodiment, the method determines a claim type to be Apparatus if:

said claim comprises no method-words;

said claim comprises no apparatus-words; and

said claim does not comprise one of ‘step’ and ‘steps’;

Or:

said claim comprises at least one apparatus-word;

said claim comprises no method-words; and

said claim does not comprise one of ‘step’ and ‘steps’;

Or:

said claim comprises at least one apparatus-word;

said claim comprises at least one method-word;

said claim does not comprise one of ‘step’ and ‘steps’;

the first of said at least one method-word is not preceded by ‘in a device’; and

said claim does not comprise a product-by-process word,

wherein the first of said at least one apparatus-words appear after the first of said at least one method-words.

In a third embodiment, the method determining a claim type to be Product-by-process if:

said claim comprises at least one method-word;

said claim comprises no apparatus-words; and

said claim comprises at least one product-by-process word;

Or:

said claim comprises at least one apparatus-word;

said claim comprises at least one method-word;

said claim does not comprise one of ‘step’ and ‘steps’;

the first of said at least one method-word is not preceded by ‘in a device’; and

said claim comprises at least one product-by-process word,

wherein the first of said at least one apparatus-word appears after the first of said at least one method-word.

In a fourth embodiment, the method determines a claim type to be method-of-producing if:

said claim comprises at least one method-word;

said claim comprises no apparatus-words;

said claim comprises no product-by-process words; and

said claim comprises at least one method-of-producing word;

Or:

said claim comprises at least one apparatus-word;

said claim comprises at least one method-word; and

said claim comprises at least one method-of-producing word,

wherein the first of said at least one method-word appears after the first of said at least one apparatus-word.

In a fifth embodiment, the method determines a claim type to be

Unknown if:

said claim comprises at least one method-word;

said claim comprises no apparatus-words;

said claim comprises no product-by-process words;

said claim comprises no method-of-producing words;

said claim does not comprise one of ‘step’ and ‘steps’; and

said claim does not start with ‘method’ or ‘a method’.

In the step of assigning a dependency-type, the method uses a Language-dependent assisting claim-words list.

In a sixth embodiment, the method assigning a claim the dependency type dependent if:

said claim comprises a claim-word followed by one or more integer numbers.

In a seventh embodiment the method builds a dependencies-tree for each dependent claim,

by assigning a pointer from the dependent claim to each of the depended-upon claims.

In an eighth embodiment, the method determines a type match between a dependent claim and the depended-upon claim if:

said dependent claim and said depended-upon claim have the same claim type;

Or:

at least one of said dependent claim and said depended-upon claim have unknown type;

Or:

said dependent claim has product-by-process type and said depended-upon claim has method type;

Or:

said dependent claim has method-of-producing type and said depended-upon claim has apparatus type.

In a ninth embodiment, the step of checking for correct syntax are:

checking for consecutive punctuation marks;

checking for existence of period at end of claim; and

checking legality of one or more periods before end of claim.

In a tenth embodiment, the method determines a period as legal if:

said period is followed by a one-character word;

Or:

said period is followed by a formula-word;

Or:

said period was preceded by one of a formula-word and a number;

Or:

said period is followed by one of a formula-word and a number.

In an eleventh embodiment, the step of checking for correct antecedent uses a language-dependent a Said-words list and comprises the steps of:

raising a flag if a first current alphanumeric word is a Said-word;

checking said flag when a second current alphanumeric word is other than a Said-word;

searching a match for said second word in a word-list of said claim being parsed, if said flag is raised,

wherein said step of searching a match determines missing antecedent for said second word if a match is not found; and

adding said second word to said word-list of said claim being parsed.

In a twelveth embodiment, the step of checking for correct antecedent additionally comprises the step of:

searching said word-list for a substitution to said second word having missing antecedent, wherein said substitution selected from a group consisting of one missing character, one additional character, one different character and two switched characters.

In another aspect there is provided a computer program product residing on a computer readable medium, said computer program product comprising instruction for causing a computer to check the correctness of at least one patent claim, said checking comprising:

checking the sequential numbering of said at least one claim;

determining a claim-type for each of said at least one claim, said claim-type selected from a group consisting of method, apparatus, product-by-process, method-of-producing and unknown;

assigning a dependency-type to each of said at least one claim, said dependency-type selected from a group consisting of dependent and independent;

building a dependencies-tree for each of said at least one claim assigned the dependency-type dependent, said dependencies-tree comprising at least one independent claim;

checking type-match for each of said dependent claims and for each of said claims in said dependencies-tree of said dependent claim; and

parsing each of said at least one claim, said parsing comprising:

i. checking for correct syntax; and

ii. checking for correct antecedent basis.

In a first embodiment, the computer program uses assisting lists. In a second preferred embodiment the assisting lists are language-dependent.

### BRIEF DESCRIPTION OF THE DRAWINGS

FIG. 1 is a general flowchart outlining the main steps of the method of the present invention;

FIG. 2 is a general flowchart of the correctness test run on each claim according to the method of the present invention;

FIGS. 3A to 3D are detailed flowcharts of the test for determining a claim type according to the method of the present invention;

FIG. 4 is a detailed flowchart of the algorithm for checking claim-dependency type match according to the method of the present invention;

FIGS. 5A and 5B are detailed flowcharts of the algorithm for parsing a claim according to the method of the present invention;

FIG. 6 is a flowchart of the AddWord process according to the method of the present invention;

FIG. 7 is a detailed flowchart of the HandleWord procedure according to the method of the present invention; and

FIG. 8 is a flowchart of the SearchCorrection procedure according to the method of the present invention.

### DETAILED DESCRIPTION OF THE INVENTION

The method of the present invention is implemented as a computer program that may run on any computer known in the art, as a stand-alone software application or in conjunction with other computer programs, such as a comprehensive software package including different tools directed at helping patent attorneys draft patent applications.

In a preferred embodiment, the method of the present invention is incorporated as an add-in to Microsoft Word, or any other word processing application used for entering text documents into a computer, whereas the patent attorney drafting the patent, and specifically the claims, may immediately, without the need to operate a separate application, check the correctness of his drafted claims and make the necessary corrections. According to the same embodiment, the errors found by the program are highlighted on the document displayed by the word processing application, with accompanying explanations and/or suggestions for correction. An alternative error report may be presented to the user in the form of a textual report, displayed or printed.

The method of the present invention may be applied, with minor variations, to US patents, European patents and others. The only variations needed are those concerning legal conventions (e.g. multiple-dependencies) The method of the present invention lends itself to patents written in English or in any other language, due to the use of assisting lists of words and phrases, as will be explained in detail hereinbelow. The user may be presented with a choice of a language from a menu, thereby effectively choosing an appropriate set of lists. In the example below the lists are described by their English content by way of an example.

The method of the present invention will now be explained in details, with reference to the accompanying drawings.

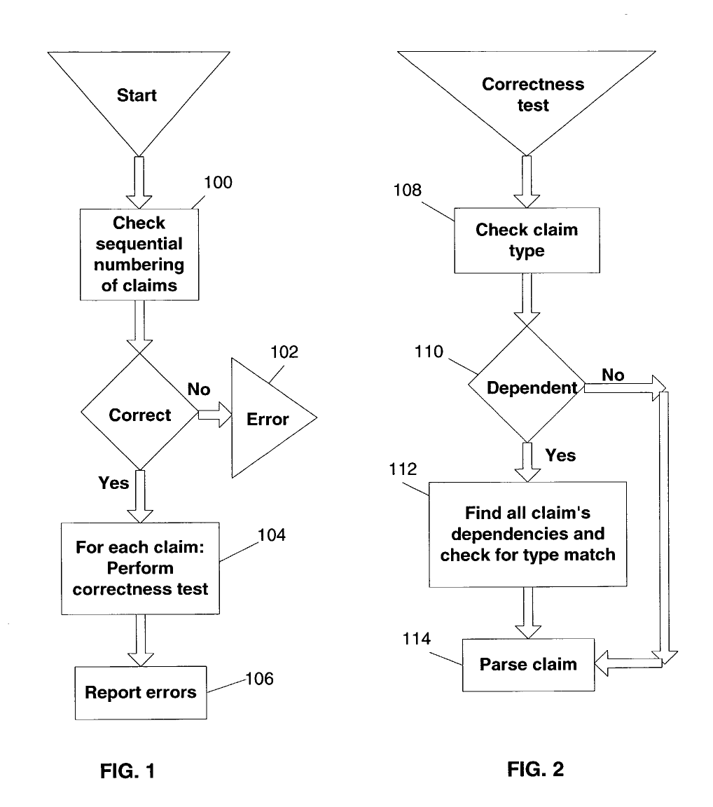

FIG. 1 outlines the main steps of the method. In step 100 the correct sequential numbering of the claims is checked. If an error is found, the user is alerted in step 102 and the program exits. The reason for stopping the checking is that wrong claims numbering may cause the program to find many further errors caused by the erroneous sequencing, thus burdening the user with lots of superfluous error messages. If the claims are found to be sequentially numbered, the program starts, in step 104, to check each claim individually, as will be explained in detail in conjunction with the following drawings. Finally, an error report is presented to the user in step 106. The error report may be presented in various modes known in the art.

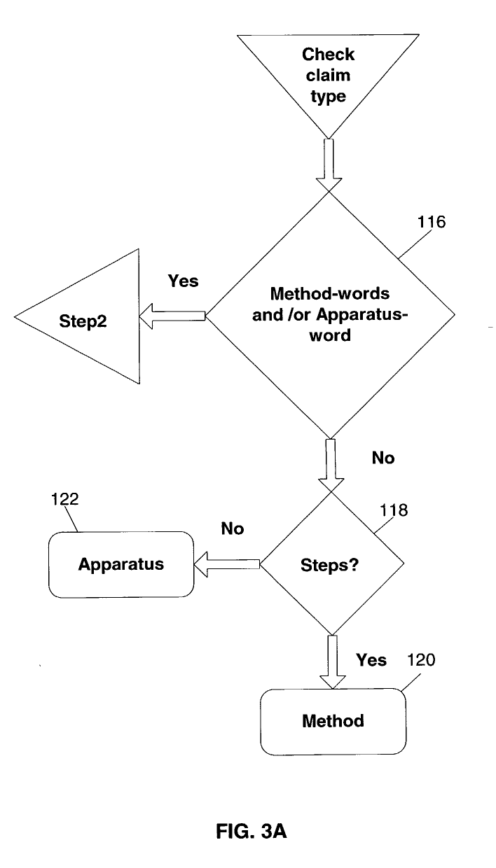

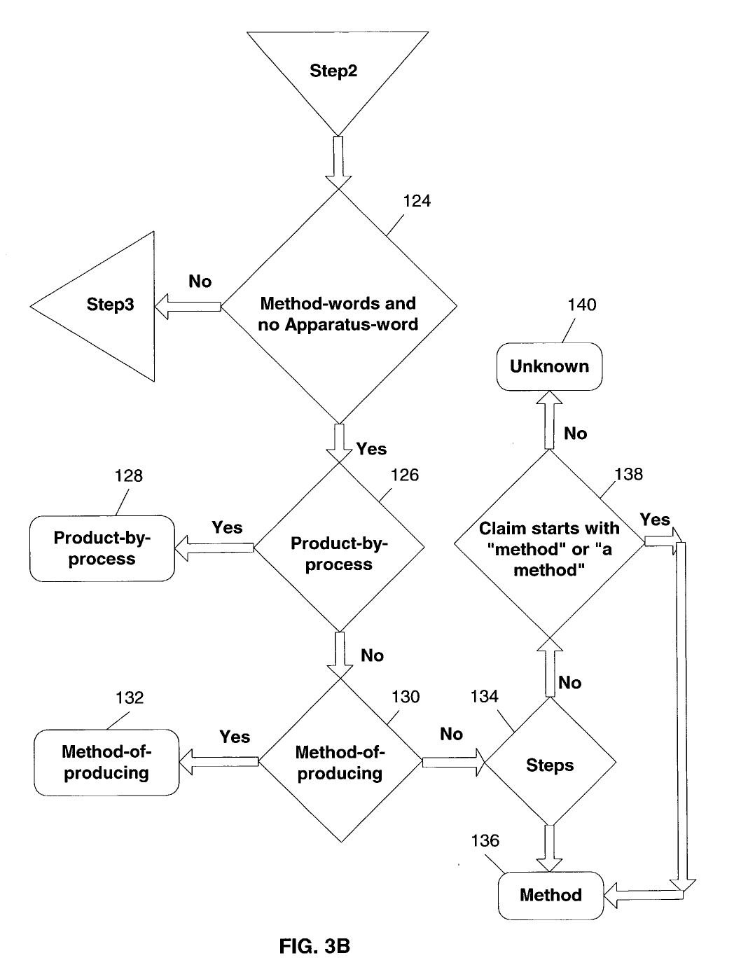

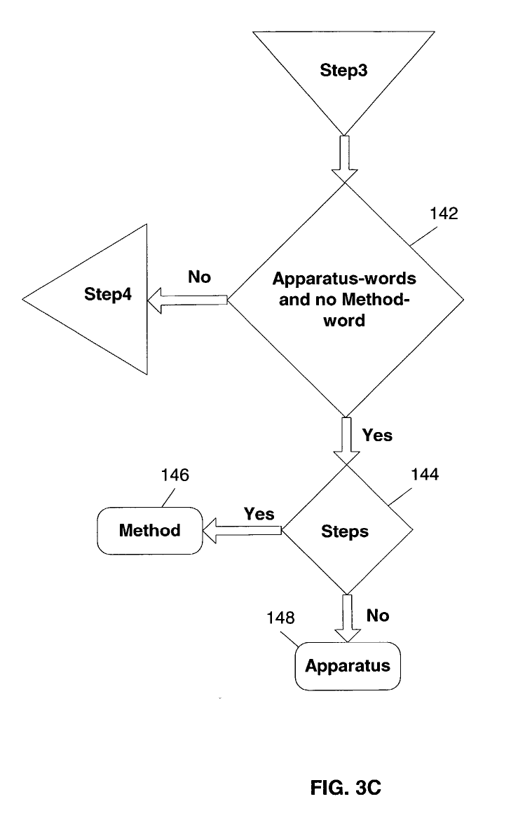

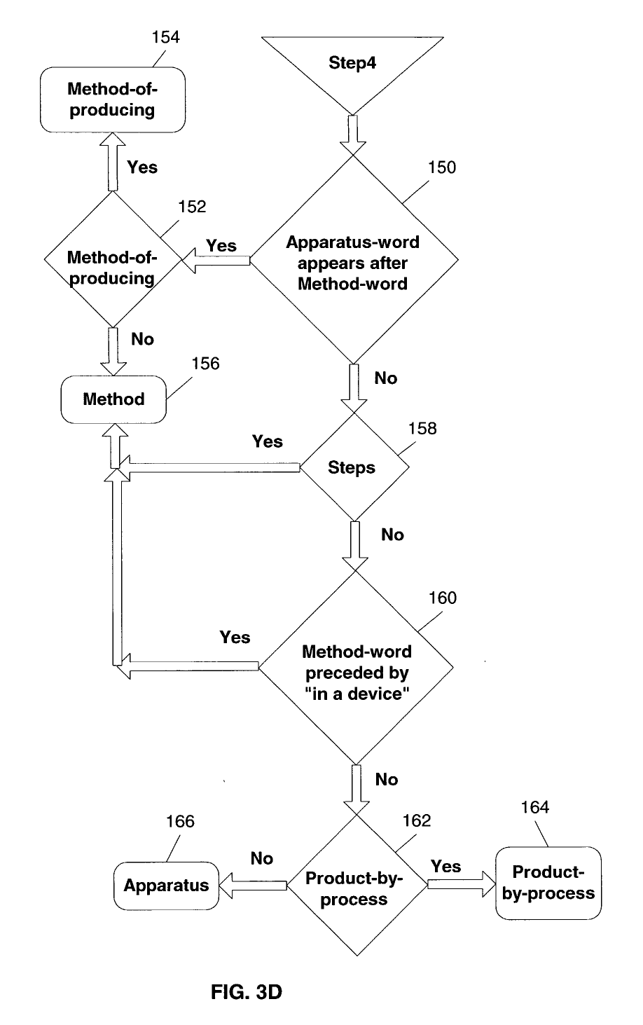

FIG. 2 is a general flowchart of the correctness test run on each claim. In step 108 a decision is made as to the claim type, as will be further explained in detail in conjunction with FIGS. 3A to 3D. In step 110, a decision is made whether the claim is a dependent claim or an independent claim. The decision is made by looking for at least one claim-word out of a claim-words list comprising the words: “claim” and “claims”. If the word “claim” is found, followed by a claim number, or “claims” followed by one of the appropriate multiple dependency forms, such as: 1 or 2, 1 to 3, 1-4, etc., the claim is defined as dependent. If the claim is found to be dependent on a claim having a bigger sequential number than that of the claim being checked—an error message will be issued.

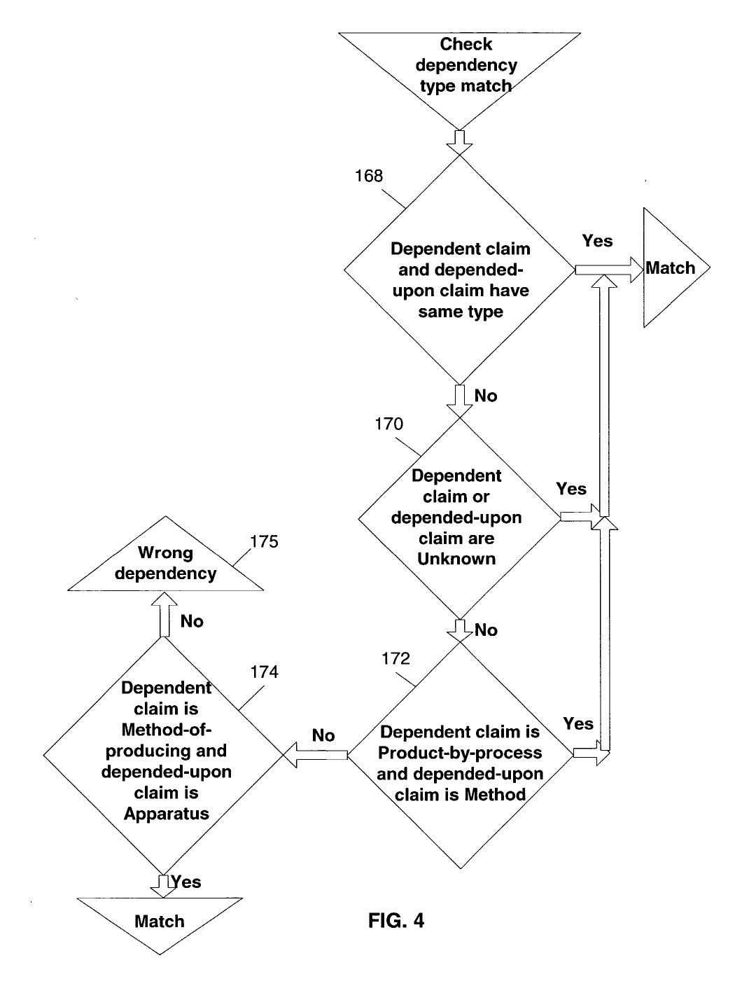

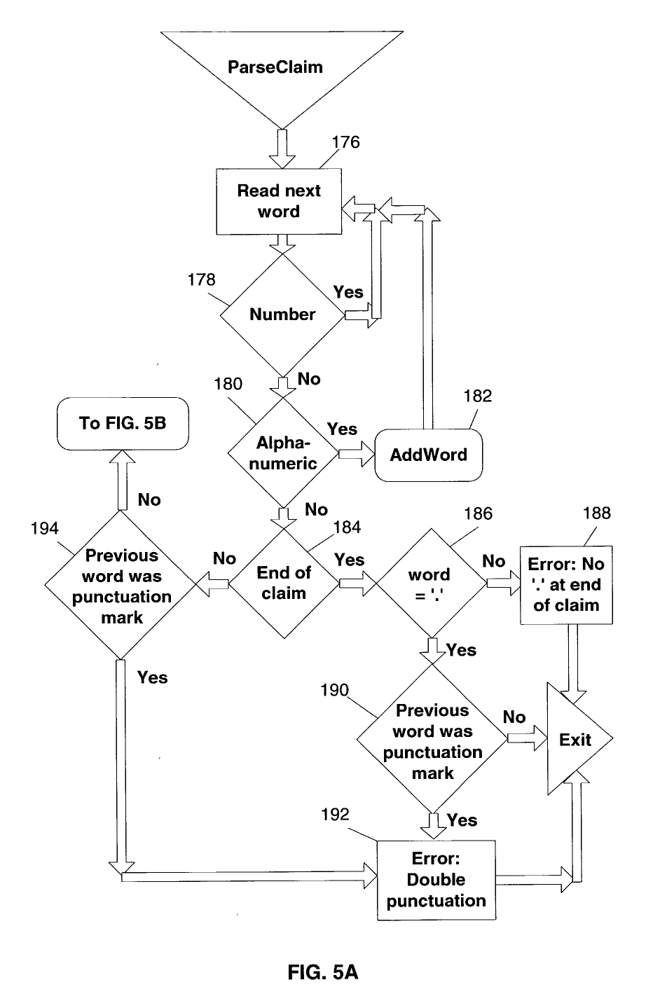

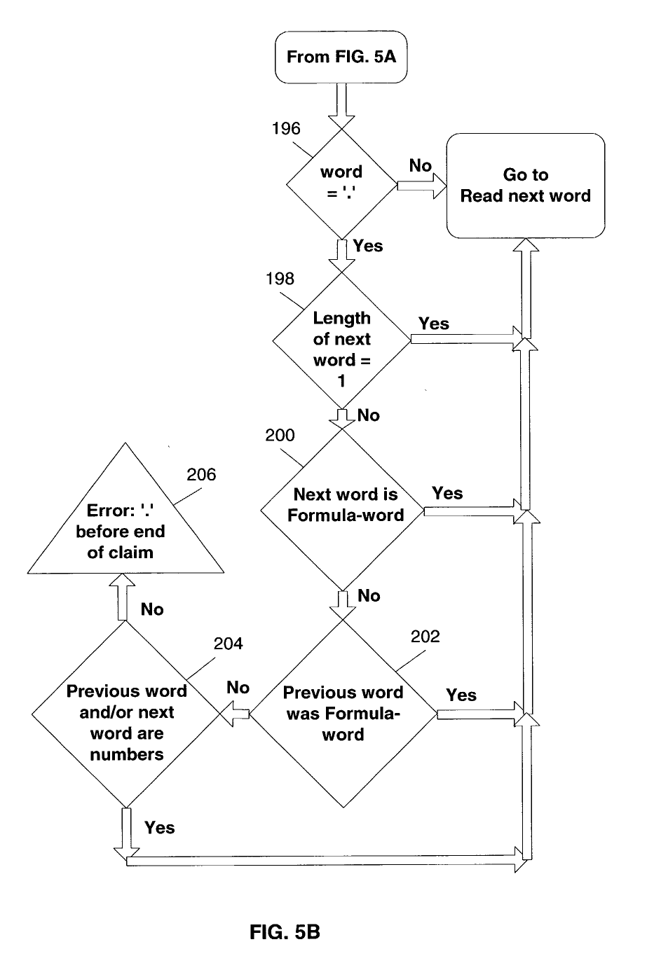

If the claim has been found to be a dependent claim, the program goes on to build one or more dependency trees for the claim. Each claim in the dependency tree is checked for type-match with the current claim, as will be explained in more detail in conjunction with FIG. 4. If a type-mismatch is found—an error message will be issued. Following the dependency type check, or if the claim was found to be an independent claim, the program now conducts, in step 114, a thorough parsing of the claim text, as will be explained in more detail in conjunction with FIGS. 5A and 5B.

FIGS. 3A-3D are a detailed flowchart of the algorithm for determining the type of a claim. The algorithm uses several lists that assist in the process of type determination:

1. Method-words list—includes the words: method, process, technique, procedure, etc.

2. Apparatus-words list—includes the words: apparatus, system, device, mechanism, machine, means, product, etc.

3. Product-by-process list—includes the words: produced, manufactured, using, etc.

4. Method-of producing list—includes the words: formulating, manufacturing, producing, incorporating, etc.

The claim types defined by the algorithm, which will be used by the next steps, are:

1. Method claim

2. Apparatus claim

3. Product-by-process claim

4. Method-of-producing claim

5. Unknown

The test for claim type begins in step 116 (FIG. 3A), by scanning the claim text

for Method-words and/or Apparatus-words, according to the appropriate lists. If none were found, the program proceeds to step 118, to look for a phrase such as “comprising the steps/step of”. If the phrase is found, the claim is categorized as a Method claim (step 120), otherwise—the claim is categorized as an Apparatus claim (step 122).

If Method-words and/or Apparatus-words were found in the claim, the program proceeds to step 2 (FIG. 3B). If only Methods-words were found (step 124), the claim is searched for Product-by-process words in step 126. The justification for this step lies in the fact that many apparatus claims do not explicitly contain words appearing in the Apparatus-words list, but rather name the claimed apparatus by its proper name, such as car, computer, etc. If Product-by-process words are found, the claim is categorized as a Product-by-process claim (step 128). Otherwise, the claim is searched, in step 130, for Method-of-producing words. If they are found—the claim is categorized as a Method-of-producing claim (step 132). Otherwise, the program proceeds to step 134, to look for a phrase such as “comprising the steps/step of”. If the phrase is found, the claim is categorized as a Method claim (step 136). Otherwise, in step 138, the program checks if the claim starts with the words “Method” or “A method”. If it does, the claim is categorized as a Method claim. Otherwise—the claim is categorized as Unknown (step 140).

If the result of the test for Method-words and no Apparatus-words (step 124) is negative, the program proceeds to step 3 (FIG. 3C). If only Apparatus-words were found (step 142), the program proceeds to step 144, to look for a phrase such as “comprising the steps/step of”. If the phrase is found, the claim is categorized as a Method claim (step 146). Otherwise, the claim is categorized as an Apparatus claim (step 148).

If the result of the test for Apparatus-words and no Method-words (step 142) is negative, then the claim contains both Apparatus-words and Method-words and the program proceeds to step 4 (FIG. 3D). In step 150 the program checks whether the Apparatus-word appears before the Method-word in the claim text. If it does, then the programs searches for a Method-of-producing word (step 152) and if found the claim is categorized as a Method-of-producing claim (step 154). If not found, the claim is categorized as a Method claim (step 156). If the Apparatus word does not appear before the Method-word, the program proceeds to step 158, to look for a phrase such as “comprising the steps/step of”. If the phrase is found, the claim is categorized as a Method claim (step 156). Otherwise, in step 160, the program checks if the Method word was preceded by a phrase such as “In a device”. If it was, the claim is categorized as a Method claim (step 156). Otherwise, the program proceeds to look for Product-by-process words and if they are found the claim is categorized as a Product-by-process claim (step 164). Otherwise, the claim is categorized as an Apparatus claim (step 166).

FIG. 4 is a flowchart of the algorithm for checking claim-dependency type match. The test is conducted only for claims that have been found to be dependent claims, as explained previously in conjunction with FIG. 2. The test is conducted for each one of the claims in the dependency tree of the claim currently being checked. If the current claim and the claim it depends on have the same type (step 168), a match is declared. If one of the current claim and the claim it depends on has Unknown type (step 170), a match is declared. This is a case where the program was unable to determine the type of a claim and the decision to declare a match serves the purpose of avoiding unjustified error messages, at the expense of overlooking a possible error. In an alternative embodiment a type mismatch may be declared in a similar situation, or a warning issued. If the current claim is a Product-by-process claim and the claim it depends on is a Method claim (step 172), a match is declared. In this case, although the claims have different types, the dependency is legitimate. Similarly, if the current claim is a Method-of-producing claim and the claim it depends on is an Apparatus claim (step 174), a match is declared. If none of the above conditions is met, a “Wrong dependency” error message will be reported (step 175).

FIGS. 5A and 5B are a detailed flowchart of the algorithm for parsing a claim, as mentioned above in conjunction with FIG. 2. In the parsing algorithm the program sequentially reads the words of the claim and performs semantic, syntactical and formality tests thereon. The parsing algorithm uses several lists that assist the process of determining whether the appearance of a certain word in the claim is legitimate:

1. Formula-words list—includes the words: sub, sup, times, degree, alpha, beta, etc.

2. Number-words list—includes the words: one, two, plurality, etc.

3. Single-plural list—includes pairs of words where the plural form is not the conventional 's, such as: half—halves, etc.

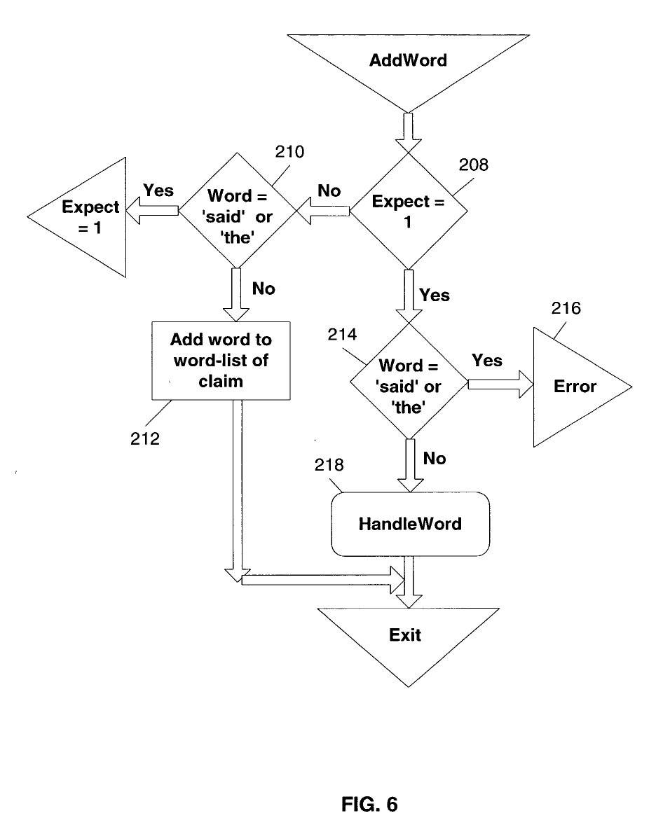

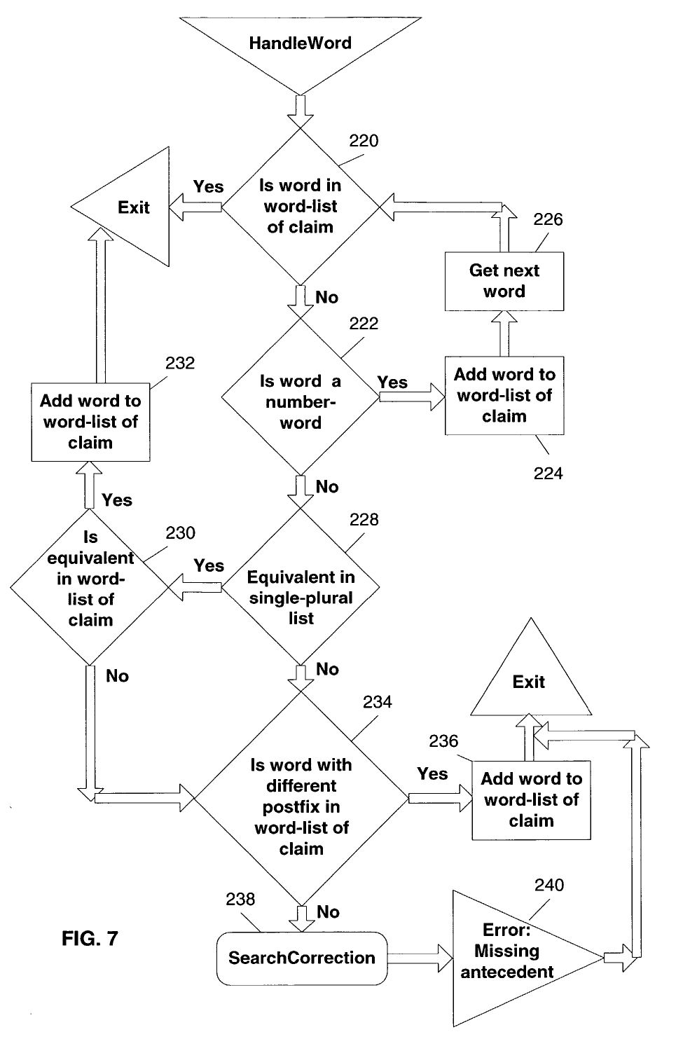

In the context of the following explanation the word “word” stands for any integral unit recognized by the parser, including numbers, punctuation marks and alphanumeric units. The parsing process ignores the claim number, which has been tested previously. In step 176 the program reads the next word. If the word is a number (step 178) the program loops back to step 176 to read the next word. Otherwise, if the word is alphanumeric (step 180), the program performs the AddWord algorithm (step 182), designed to list all the alphanumeric words of each claim, for subsequent “antecedent testing”, as will be explained in detail in conjunction with FIGS. 6 and 7. The program then loops back to step 176 to read the next word. If the word is not alphanumeric, the program proceeds to step 184 to check if the word is the last word of the claim. If it is (step 186), and the word is not a period (‘.’), an error condition is saved (“No ‘.’ at end of claim”) in step 188 and the program exits. Otherwise, if the word is a period, the program checks in step 190 whether the previous word had also been a punctuation mark. If it was, an error condition is saved (“Consecutive punctuation marks”) in step 192 and the program exits. If no error was found in step 190 the claim parsing is finished and the program exits. If step 184 determines that the current word is not the last word in the claim, the program checks in step 194 whether the previous word had also been a punctuation mark. If it was, an error condition is saved (“Consecutive punctuation marks”) in step 192 and the program exits. Otherwise, the word is tested for period (step 196, FIG. 5B). If it is not a period the program loops back to step 176 to read the next word. Otherwise, if the word is a period (not at the end of claim), the program proceeds to check whether the period is legitimate in the context of its neighboring words: In step 198, the program check if the length of the following word is 1. If it is, a legitimate appearance of a period in the middle of a claim is declared and the program loops back to step 176 to read the next word. This covers cases such as the phrase “r.p.m.” appearing in a claim. Otherwise, if the following word is a Formula-word (step 200), a legitimate appearance of a period in the middle of a claim is declared and the program loops back to step 176 to read the next word. This covers cases such as the phrase “degree.C” appearing in a claim. Otherwise, if the preceding word was a Formula-word (step 202), a legitimate appearance of a period in the middle of a claim is declared and the program loops back to step 176 to read the next word. This covers cases such as the phrase “.degree.C” appearing in a claim. Otherwise, if the preceding word and/or the following word are numbers (step 204), a legitimate appearance of a period in the middle of a claim is declared and the program loops back to step 176 to read the next word. If none of the above conditions has been met, an error condition is saved (“‘.’ before end of claim”) in step 206 and the program exits. FIG. 6 is a flowchart of the AddWord process, mentioned above in conjunction with FIG. 5A. Add_Word uses a Said_words list comprising the words “said” and “the”. A flag named “Expect” is used to test for words following a Said_words, which are expected to have been previously added to the word-list of the currently checked claim or the preceding claims in its dependency tree. If the Expect flag is OFF (step 208), the program proceeds to step 210 to check whether the current word is a Said_word. If it is, the Expect flag is turned ON and the program exits. If the current word is not a Said_word, the current word is added to the claim's word-list (step 212) and the program exits. If the Expect flag is ON (step 208), the program checks in step 214 whether the current word is a Said_word. If it is, an error condition is saved (“said said”) in step 216 and the program exits. Otherwise, the HandleWord procedure is performed in step 218, to determine whether the word has an antecedent, as will be explained in detail in conjunction with FIG. 7 and the program exits.

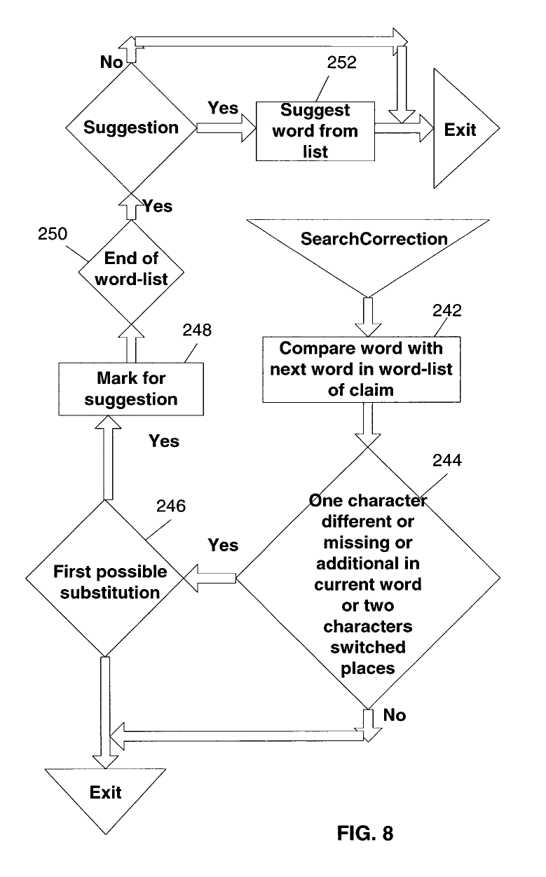

FIG. 7 is a detailed flowchart of the HandleWord procedure, designed to determine whether the current word, which was preceded by a Said_word, has an antecedent. In step 220, a match for the current word is searched in the word-list of the current claim and, if the claim is dependent, also in the wordlists of all the preceding claims in its dependency tree(s). If a match is found, the program exits. Otherwise, if the current word is a Number-word (step 222), the word is added to the word-list of the claim (step 224), the next word is read (step 226) and the program loops back to step 220. This covers cases such as “said two sensors”, preceded by a description of e.g. “a first sensor . . . and a second sensor”. If the current word is not a Number-word (step 222), the Single-plural list is searched for an equivalent (step 228). If an equivalent is found (step 230), the program proceeds to step 232 where the current word is added to the word-list of the claim and the program exits. This covers cases such as “a first knife . . . . a second knife . . . said knives”. If an equivalent was not found in the Single-plural list, the program proceeds to step 234, to check whether the root of the current word has previously appeared with a different postfix. If a match is found, the current word is added to the word-list of the claim (step 236) and the program exits. This covers cases such as “imaging a printing plate . . . . said imaged printing plate”. If no suitable word with a different postfix has been found, the program determines that the current word has no antecedent and proceeds to step 238 to perform the SearchCorrection procedure, designed to attempt a suggested correction, which will be described in detail in conjunction with FIG. 8. An error message is saved (“Missing antecedent”) in step 240 and the program exits.

FIG. 8 is a flowchart of the SearchCorrection procedure, designed to search for a possible substitute for a word that has been determined to have no antecedent by the HandleWord process. The current word is sequentially compared with all the words in the word-list of the claim and, if claim is dependent, in the word-lists of all the preceding claims in its dependency tree. If more than one possible substitute is found, the procedure does not suggest it to the user. In step 242, the current word is compared with the next word in the relevant word-list(s). If the words are identical, except for one character missing in the current word (step 244), the program checks (step 246) whether this is the first possible substitution found. If it is, the program proceeds to step 248 to mark the found word as a possible substitution and loops back to step 250 to check whether the word-list(s) has been exhausted. If it has, the program checks whether a possible substitution has been found and saves it as a suggestion for substitution (step 252) before exiting. If the possible substitution found is not the first (step 246), the program exits. If the words are identical except for one additional character in the current word, or one character difference, or if the two words differ only by two characters having switched places, the same procedure is followed. Otherwise, the program exits not having found a possible substitution to the word with missing antecedent.

What is claimed is:

1. A method of checking the correctness of at least one patent claim, said method comprising the steps of:
checking the sequential numbering of said at least one claim;
determining a claim-type for each of said at least one claim, said claim-type selected from a group consisting of method, apparatus, product-by-process, method-of-producing and unknown;
assigning a dependency-type to each of said at least one claim, said dependency-type selected from a group consisting of dependent and independent;
building a dependencies-tree for each of said at least one claim assigned the dependency-type dependent in said step of assigning, said dependencies-tree comprising at least one independent claim;
checking type-match for each of said dependent claims and for each of said claims in said dependencies-tree of said dependent claim; and
parsing each of said at least one claim, said step of parsing comprising the steps of:
a. checking for correct syntax; and
b. checking for correct antecedent basis.

2. The method of claim 1, wherein said step of determining a claim-type comprises using assisting lists, said lists comprising: a method-words list, an apparatus-words list, a product-by-process list and a method-of producing list.

3. The method of claim 2 wherein said lists are language-dependent.

4. The method of claim 3, wherein said step of determining a claim type comprises determining said claim type as method if:
said claim comprises no method-words;
said claim comprises no apparatus-words; and
said claim comprises one of ‘step’ and ‘steps’.

5. The method of claim 3, wherein said step of determining a claim type comprises determining said claim type as method if:
said claim comprises at least one method-word;
said claim comprises no apparatus-words;
said claim comprises no product-by-process words;
said claim comprises no method-of-producing words; and
said claim comprises at least one of a group consisting of ‘step’ and ‘steps’ and;
said claim starts with ‘method’ or ‘a method’.

6. The method of claim 3, wherein said step of determining a claim type comprises determining said claim type as method if:
said claim comprises at least one apparatus-word;
said claim comprises no method-words; and
said claim comprises one of ‘step’ and ‘steps’.

7. The method of claim 3, wherein said step of determining a claim type comprises determining said claim type as method if:
said claim comprises at least one apparatus-word;
said claim comprises at least one method-word; and
said claim comprises no method-of-producing words,
wherein the first of said at least one apparatus-word appears after the first of said at least one method-word.

8. The method of claim 3, wherein said step of determining a claim type comprises determining said claim type as method if:
said claim comprises at least one apparatus-word;
said claim comprises at least one method-word; and
said claim comprises one of ‘step’ and ‘steps’,
wherein the first of said at least one apparatus-word appears after the first of said at least one apparatus-word.

9. The method of claim 3, wherein said step of determining a claim type comprises determining said claim type as apparatus if:
said claim comprises no method-words;
said claim comprises no apparatus-words; and
said claim does not comprise one of ‘step’ and ‘steps’.

10. The method of claim 3, wherein said step of determining a claim type comprises determining said claim type as apparatus if:
said claim comprises at least one apparatus-word;
said claim comprises no method-words; and
said claim does not comprise one of ‘step’ and ‘steps’.

11. The method of claim 3, wherein said step of determining a claim type comprises determining said claim type as apparatus if:
said claim comprises at least one apparatus-word;
said claim comprises at least one method-word;
said claim does not comprise one of ‘step’ and ‘steps’;
the first of said at least one method-word is not preceded by ‘in a device’; and
said claim does not comprise a product-by-process word,
wherein the first of said at least one apparatus-words appear after the first of said at least one method-words.

12. The method of claim 3, wherein said step of determining a claim type comprises determining said claim type as product-by-process if:
said claim comprises at least one method-word;
said claim comprises no apparatus-words; and
said claim comprises at least one product-by-process word.

13. The method of claim 3, wherein said step of determining a claim type comprises determining said claim type as product-by-process if:
said claim comprises at least one apparatus-word;
said claim comprises at least one method-word;
said claim does not comprise one of ‘step’ and ‘steps’;
the first of said at least one method-word is not preceded by ‘in a device’; and
said claim comprises at least one product-by-process word, 1
wherein the first of said at least one apparatus-word appears after the first of said at least one method-word.

14. The method of claim 3, wherein said step of determining a claim type comprises determining said claim type as method-of-producing if:
said claim comprises at least one method-word;
said claim comprises no apparatus-words;
said claim comprises no product-by-process words; and
said claim comprises at least one method-of-producing word.

15. The method of claim 3, wherein said step of determining a claim type comprises determining said claim type as method-of-producing if:
said claim comprises at least one apparatus-word;
said claim comprises at least one method-word; and
said claim comprises at least one method-of-producing word,
wherein the first of said at least one method-word appears after the first of said at least one apparatus-word.

16. The method of claim 3, wherein said step of determining a claim type comprises determining said claim type as unknown if:
said claim comprises at least one method-word;
said claim comprises no apparatus-words;
said claim comprises no product-by-process words;
said claim comprises no method-of-producing words;
said claim does not comprise one of ‘step’ and ‘steps’; and
said claim does not start with ‘method’ or ‘a method’.

17. The method of claim 1, wherein said step of assigning a dependency-Type comprises using an assisting claim-words list.

18. The method of claim 17 wherein said list is language-dependent.

19. The method of claim 18, wherein said step of assigning a dependency-type to a claim comprises assigning said claim the dependency type dependent if:
said claim comprises a claim-word followed by one or more integer numbers.

20. The method of claim 19, wherein the step of building a dependencies-tree for a dependent claim comprises assigning a pointer from said dependent claim to each of the claims having said integer numbers as sequential number.

21. The method of claim 1, wherein said step of checking type-match determines a type match if:
said dependent claim and said dependencies-tree claim have the same claim type.

22. The method of claim 1, wherein said step of checking type-match determines a type match if:
at least one of said dependent claim and said dependencies-tree claim have unknown type.

23. The method of claim 1, wherein said step of checking type-match determines a type match if:
said dependent claim has product-by-process type and said dependencies-tree claim has method type.

24. The method of claim 1, wherein said step of checking type-match determines a type match if:
said dependent claim has method-of-producing type and said dependencies-tree claim has apparatus type.

25. The method of claim 1, wherein said step of checking for correct syntax comprises the steps of:
checking for consecutive punctuation marks;
checking for existence of period at end of claim; and
checking legality of one or more periods before end of claim.

26. The method of claim 25, wherein said step of checking legality comprises determining a period as legal if:
said period is followed by a one-character word.

27. The method of claim 25, wherein said step of checking legality comprises determining a period as legal if:
said period is followed by a formula-word.

28. The method of claim 25, wherein said step of checking legality comprises determining a period as legal if:
said period was preceded by one of a formula-word and a number.

29. The method of claim 25, wherein said step of checking legality comprises determining a period as legal if:
said period is followed by one of a formula-word and a number.

30. The method of claim 1, wherein said step of checking for correct antecedent comprises using a Said-words list.

31. The method of claim 30 wherein said list is language-dependent.

32. The method of claim 31, wherein said step of checking for correct antecedent basis comprises the steps of:
raising a flag if a first current alphanumeric word is a Said-word;
checking said flag when a second current alphanumeric word is other than a Said-word;
searching a match for said second word in a word-list of said claim being parsed, if said flag is raised,
wherein said step of searching a match determines missing antecedent for said second word if a match is not found; and
adding said second word to said word-list of said claim being parsed if a match was not found in said step of searching.

33. The method of claim 32, additionally comprising the step of:
searching said word-list for a substitution to said second word having missing antecedent.

34. The method of claim 33, wherein said substitution selected from a group consisting of one missing character, one additional character, one different character and two switched characters.

35. A computer program product residing on a computer readable medium, said computer program product comprising instruction for causing a computer to check the correctness of at least one patent claim, said checking comprising:
checking the sequential numbering of said at least one claim;
determining a claim-type for each of said at least one claim, said claim-type selected from a group consisting of method, apparatus, product-by-process, method-of-producing and unknown;
assigning a dependency-type to each of said at least one claim, said dependency-type selected from a group consisting of dependent and independent;
building a dependencies-tree for each of said at least one claim assigned the dependency-type dependent, said dependencies-tree comprising at least one independent claim;
checking type-match for each of said dependent claims and for each of said claims in said dependencies-tree of said dependent claim; and
parsing each of said at least one claim, said parsing comprising:
i. checking for correct syntax; and
ii. checking for correct antecedent basis.

36. The computer program product of claim 35 wherein said computer program product uses assisting lists.

37. The computer program product of claim 36 wherein said assisting lists are language-dependent.
